(19) United States
(12) Patent Application Publication
(10) Pub. No.: US 2008/0313558 A1
(43) Pub. Date: Dec. 18, 2008

(54) SYSTEM AND METHOD FOR MANAGING MEDIA WITH VIRTUAL DIRECTORIES

(76) Inventors: Jeyhan Karaoguz, Irvine, CA (US); Arya Behzad, Poway, CA (US); Mark Buer, Gilbert, AZ (US); Alexander G. MacInnis, Ann Arbor, MI (US); Thomas Quigley, Franklin, NC (US); John Walley, Ladera Ranch, CA (US)

Correspondence Address: MCANDREWS HELD & MALLOY, LTD, 500 WEST MADISON STREET, SUITE 3400, CHICAGO, IL, 60661, US

(21) Appl. No.: 12/119,056

(22) Filed: May 12, 2008

Related U.S. Application Data
(60) Provisional application No. 60/943,474, filed on Jun. 12, 2007.

(51) Int. Cl. G06F 3/048

(52) U.S. Cl. 715/771

(57) ABSTRACT

A system and method for managing media files (e.g., utilizing virtual directories). Various aspects of the present invention, for example, comprise interacting with a user to define one or more virtual file directories and/or associated media file characteristics. One or more media file characteristics may, for example, be associated with a media file. Such associated media file characteristics may, for example, be analyzed to determine whether to associate a media file with one or more virtual directories.

### CROSS-REFERENCE TO RELATED APPLICATIONS/INCORPORATION BY REFERENCE

This patent application is related to and claims priority from provisional patent application Ser. No. 60/943,474 filed Jun. 12, 2007, and titled “SYSTEM AND METHOD FOR MANAGING MEDIA WITH VIRTUAL DIRECTORIES,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Users are creating and/or accumulating media files of all types at an increasing rate. The accumulation of such media files creates issues related to efficiently storing and/or accessing such files.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for managing media files (e.g., utilizing virtual directories) substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 illustrates an exemplary media file management scenario comprising virtual directories, in accordance with various aspects of the present invention.

FIG. 2 illustrates an exemplary system scenario, in accordance with various aspects of the present invention.

FIG. 3 is a flow diagram illustrating an exemplary method in a computing system for managing media files, in accordance with various aspects of the present invention.

FIG. 4 is a flow diagram illustrating an exemplary method in a computing system for managing media files, in accordance with various aspects of the present invention.

FIG. 5 is a flow diagram illustrating an exemplary method in an electronic device for managing media files, in accordance with various aspects of the present invention.

### DETAILED DESCRIPTION OF THE INVENTION

The following discussion will generally discuss virtual and standard (also non-virtual) directories for media files. Standard (or non-virtual) directories will generally be considered to be a primary directory into which a media file is placed. For example, when a user executes a “file move”, “file download”, “file create” or “file copy” command, the result is generally a file being created in memory and a reference to such file being placed in a standard directory. In other words, a standard (or non-virtual) directory is the type of directory that is generally associated with typical computer file management.

In comparison, virtual file directories will generally be considered to be directories that refer to (e.g., link to or point to) the files that are already contained in standard directories (e.g., local or remote standard directories). As a non-limiting example, a particular media file may be downloaded or otherwise copied into memory and placed into a standard file directory in accordance with typical file management procedures, and one or more virtual directories may also be created, where such virtual directories include references to (e.g., links to or pointers to) the particular media file. Thus, a single copy of a particular media file in memory may appear to be in a plurality of directories (e.g., a standard file directory and one or more virtual directories).

As with standard file directories, one or more virtual file directories may, for example, be defined in a tree-shaped architecture with nested directories. Also for example, one or more virtual file directories may be defined in a flat non-nested architecture or in any accordance with any of a variety of other directory architectures.

A virtual file directory will generally be formed and continue to exist and to be maintained whether currently being utilized or not. Thus, unlike performing a search for particular types of files on an as-needed basis in real-time, the virtual file directory may be formed and continually maintained, so-as to be available and ready for utilization when a user desires to utilize the virtual directory. In other words, a virtual file directory associated with media files having particular characteristics may be created and maintained prior to a user request to access media files having the particular characteristics. In a scenario involving a relatively large store of media files and/or relatively large media files, avoiding performing real-time searches for media files having particular characteristics is desirable for various reasons, including but not limited to, reduced latency and reduced real-time processing cycles and/or power consumption.

The following discussion will often refer to media files. Such media files are generally associated with providing information to a user. The most popular variants of such media files describe visual and/or audio information, generally utilizing efficient encoding schemes, for ultimate presentation to a user in a user-perceivable form. For example and without limitation, a media file may be a data file describing a picture or still image file in accordance with any of a variety of standard and/or proprietary formats (e.g., JPEG, TIFF, etc.). Also for example, a media file may be a data file describing a video or moving picture in accordance with any of a variety of standard and/or proprietary formats (e.g., MPEG). Further for example, a media file may be a data file describing an audio presentation, like music or other audio recording in accordance with any of a variety of standard and/or proprietary formats (e.g., MP3, AAC, MIDI, QCELP, AMR, CMX, VoIP, etc.).

The media files may, for example, be a user's original works of authorship. For example, the media files may generated by a consumer electronic device, such as a digital camera, video camera, scanner, audio recorder, etc., under the control of the user. In some instances, the media files may be acquired by a user from a source other than the user's personal equipment (e.g., downloaded freely, purchased from a commercial source, etc.).

The following discussion will also refer to media file characteristics. Such characteristics may generally refer to descriptive characteristics of a media file. Various aspects of the present invention may refer to user-defined and system-defined (or non-user-defined) media file characteristics. For example, a user may define or specify various characteristics of media files that the user may desire to be utilized to classify the media files. Also, various characteristics may be generally common between users, and such characteristics may be defined by the system (e.g., as part of system software).

In an exemplary scenario involving photographic media files, non-limiting examples of such media file characteristics may comprise: subject of photograph, time of photograph, geographical location of photograph, person taking photograph, pointing direction of camera, date of photograph, event at which photograph was taken, general or specific subject matter, particular camera settings used when taking photograph, people in photograph, objects in photograph, place of photograph, colors in photograph, etc. In another exemplary scenario involving audio media files, non-limiting examples of such media file characteristics may comprise: subject of audio recording, sound source, audio recorder settings, time of audio recording, place of audio recording, geographical location of recording, event at which recording was made, source of audio media file, type of audio recording, audio frequency content, etc. Additional exemplary features that may be associated with media file characteristics will be presented later.

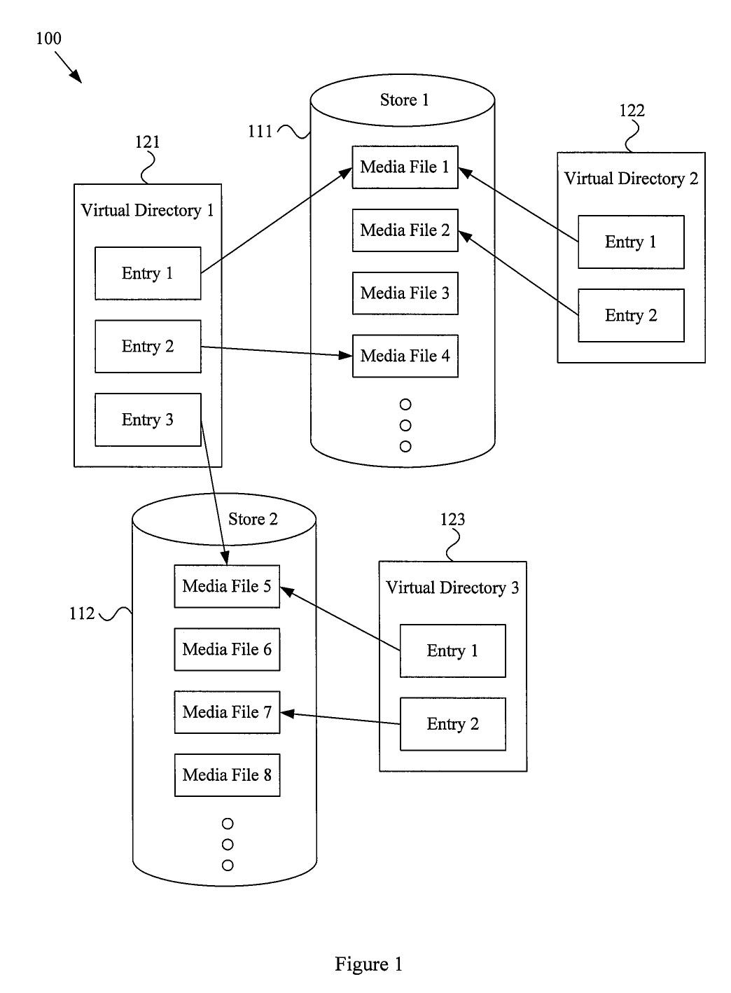

FIG. 1 illustrates an exemplary media file management scenario 100 comprising virtual directories, in accordance with various aspects of the present invention. The exemplary scenario comprises a first memory 111 (or store), in which is stored a plurality of media files. Though not illustrated in FIG. 1, one or more standard file directories refer to the plurality of media files. For example, when a user caused the media files to be stored in the first memory 111, the user may have specified that the files be stored in the first memory 111 and associated with a standard file directory.

Similarly, the exemplary scenario 100 also comprises a second memory 112, in which is stored a plurality of media files. Similarly, though not illustrated in FIG. 1, one or more standard file directories refer to the plurality of media files stored in the second memory 112. For example, when a user caused the media files to be stored in the second memory device 112, the user may have specified that the files be stored in the second memory 112 and associated with a standard file directory.

The first and second memory 111, 112 may comprise characteristics associated with any of a variety of memory types. For example and without limitation, the first and second memory 111, 112 may comprise characteristics of a local computer hard drive, magnetic storage device, optical storage device, volatile memory device, non-volatile memory device, solid state memory device, etc. Also for example, the first and second memory 111, 112 may comprise characteristics of a memory that is coupled to a computing system through any of a variety of communication networks (e.g., through a local area network (LAN), the Internet, a metropolitan area network (MAN), a personal area network (PAN), wide area network (WAN), a cellular telephone network, a cable television network, a satellite communication network, etc.).

The exemplary environment 100 may also comprise a first virtual directory 121. The first virtual directory 121 may, for example, comprise one or more entries that are associated with (e.g., comprising links to) respective media files stored in the first memory 111 (e.g., Media File 1 and Media File 4 of the first memory 111). Such media files are also, for example, associated with a standard file directory. The first virtual directory 121 may also, for example, comprise one or more entries that are associated with respective media files stored in the second memory 112 (e.g., Media file 5 of the second memory 112). Thus, in the exemplary scenario 100, the first virtual directory 121 comprises entries associated with media files stored in a plurality of memories.

The exemplary environment 100 may also comprise a second virtual directory 122. The second virtual directory 122 may, for example, comprise one or more entries that are associated with (e.g., comprising links to) respective media files stored in the first memory 111 (e.g., Media File 1 and Media File 2 of the first memory 111). Such media files are also, for example, associated with a standard file directory. Note that in the exemplary environment 100, Media File 1 of the first memory 111 is associated with the first virtual directory 121 and the second virtual directory 122, as well as a standard file directory. For example, if a user opens the appropriate standard file directory, the user will see an indication of Media File 1; if a user opens the first virtual directory 121, the user will see an indication of Media File 1; and if a user opens the second virtual directory 122, the user will see an indication of Media File 1.

The exemplary environment 100 may also comprise a third virtual directory 123. The third virtual directory 123 may, for example, comprise one or more entries that are associated with (e.g., comprising links to) respective media files stored in the second memory 112 (e.g., Media File 5 and Media File 7 of the second memory 112). Such media files are also, for example, associated with a standard file directory. Note that in the exemplary environment 100, Media File 5 of the second memory 112 is associated with the first virtual directory 121 and the third virtual directory 123, as well as a standard file directory. For example, if a user opens the appropriate standard file directory, the user will see an indication of Media File 5; if a user opens the first virtual directory 121, the user will see an indication of Media File 5; and if a user opens the third virtual directory 123, the user will see an indication of Media File 5.

In the exemplary environment, the first memory 111 (e.g., Media File 3) and the second memory 112 (e.g., Media File 6 and Media File 8) each include media files that are associated with standard file directories but not a virtual directory.

The exemplary environment 100 does not illustrate a geographical or system location associated with the various components. The first and second memories 111, 112 may be co-located or may be geographically separated. For example, the first and second memories 111, 112 may both be associated with a first computing system (e.g., a home computing system). Also for example, the first memory 111 may be a local memory of a computing system, and the second memory 112 may be remote relative to the computing system (e.g., communicatively coupled to a computing system through a communication network). Further for example, at least one of the first and second memories 111, 112 may be a memory of a media recording device utilized to generate media files (e.g., a digital camera, camcorder, or audio recording device). In general, the first and second memories 111, 112 may be located in any of a large variety of places.

The exemplary environment 100 also does not illustrate a geographical or system location associated with the various virtual directories 121-123. Such virtual directories 121-123 may be maintained in any of a variety of systems or devices and at any of a variety of locations (e.g., any of a variety of premises). For example, the virtual directories 121-123 may be maintained in a single computing system (e.g., a personal computing system). Also, for example, one or more of the virtual directories 121-123 may also be maintained in a media recording device utilized to generate media files (e.g., a digital camera, camcorder, or audio recording device). Further for example, one or more of the virtual directories 121-123 may be maintained on a networked computing system accessible to the user.

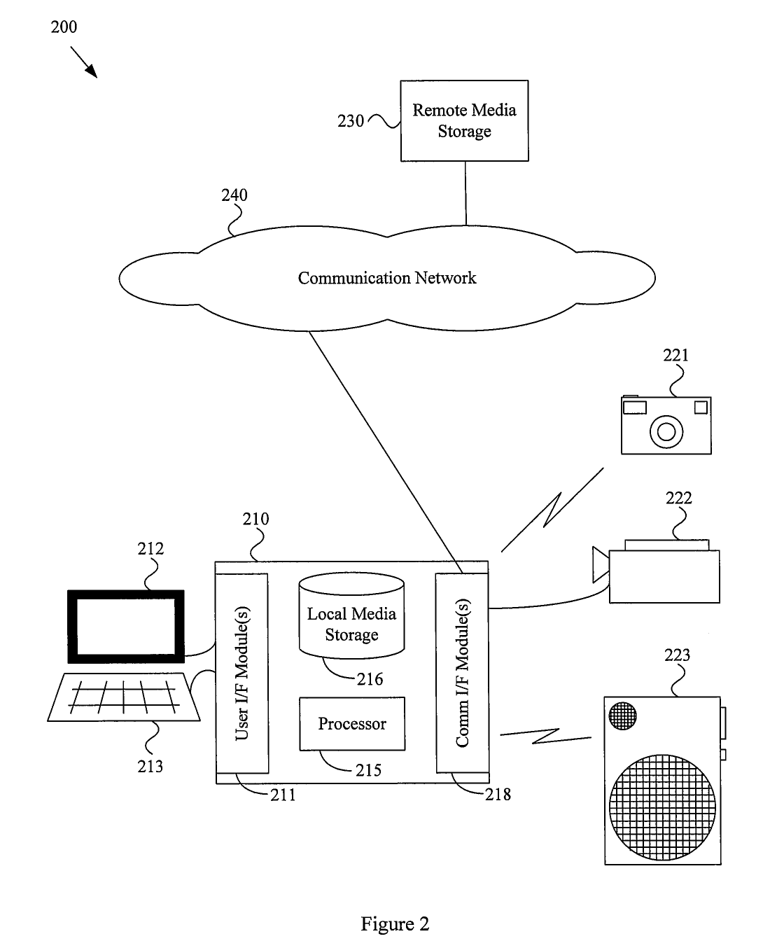

Turning next to FIG. 2, such figure illustrates a non-limiting exemplary system scenario 200, in accordance with various aspects of the present invention. The exemplary system 200 comprises a computing system 210. The computing system 210 may comprise characteristics of any of a variety of types of computing systems. For example and without limitation, the computing system 210 may comprise characteristics of a personal computer (e.g., a general-purpose desktop computer, laptop computer, notebook computer, pocket computer, etc.). Also for example, the computing system 210 may comprise characteristics of any of a variety of electronic devices (e.g., consumer electronic devices) comprising computing capability (e.g., a cellular telephone, portable email device, portable media playing device, camera, video recorder, personal digital assistant, cable or satellite television receiver, personal video recorder, television, telephone system, scanner, etc.). The scope of various aspects of the present invention should not be limited by characteristics of a particular type of computing system unless explicitly claimed.

The computing system 210 may comprise a variety of components, non-limiting illustrative examples of which are shown in FIG. 2. For example, the computing system 210 may comprise one or more user interface modules 211. Such user interface module(s) 211 may comprise characteristics of any of a variety of types of user interface modules (hardware and/or software). For example and without limitation, such user interface module(s) 211 may comprise characteristics of any of a variety of hardware, software, user input devices and/or user output devices, etc. For example, such user interface module(s) 211 may comprise hardware and/or software that operates to interface with a user visually (e.g., with a display, camera, etc.), audibly (e.g., with a speaker, microphone, etc.) or with tactile I/O devices (e.g., with a touch screen, vibration device, keypad, mouse, trackball, touchpad, various touch sensors, eye sensors, head motion sensors, etc.). In the non-limiting exemplary system 200 illustrated in FIG. 2, particular user interface devices communicatively coupled to the computing system 210 include a display (or monitor) 212 and a keyboard 213.

The computing system 210 may also comprise one or more communication interface modules 218. Such communication interface module(s) 218 may comprise characteristics of any of a variety of types of communication interface modules (hardware and/or software). Such communication interface module(s) 218 may be operable to perform communications between the computing system 210 and any of a large variety of other entities through any of a large variety of communication networks. Non-limiting examples of such communication interface module(s) 218 include hardware and/or software modules that operate to communicate with other entities through any of a variety of types of communication interfaces or networks and utilizing any of a variety of communication protocols (e.g., Bluetooth, IEEE 802.11, IEEE 802.15, IEEE 802.16, IEEE 802.20, GSM/GPRS/EDGE, CDMA/CDMA 2000/WCDMA, TDMA/PDC, H.232, SIP, MGCP/MEGACO, TCP/IP, Token Ring, Ethernet, ALOHA, etc.). The communication interface module(s) 218 may also, for example, comprise one or more modem interface modules, USB interface modules, FireWire interface modules and/or various memory interface modules. The communication interface module(s) 218 may additionally, for example, comprise any of a variety of front-end communication circuits associated with communicating over a particular communication medium (e.g., wired, wireless, tethered optical, non-tethered optical, etc.). The exemplary system scenario 200 shows a single communication network 240, but in general, the communication interface module(s) 218 may operate to communicate with any number of communication networks (e.g., simultaneously, concurrently, serially, etc.).

The computing system 210 may also comprise one or more memories (or memory devices) 216. Such memory 216 may comprise characteristics of any of a variety of memory types and/or devices. For example and without limitation, such memory 216 may comprise characteristics of random access memory (RAM), read-only memory (ROM), volatile memory, non-volatile memory, hard drive memory, optical memory, magnetic memory, removable disk memory, on-board or off-board memory, flash memory, EPROM memory, EEPROM memory, local memory, non-local networked memory, etc. The computing system 210 may, for example, utilize memory 216 to store any of a variety of types of information. Such information may, for example and without limitation, comprise general data, executable software instructions and/or media files. For example and without limitation, the memory 216 may comprise one or more stores of media files, such as the first and/or second memories 111, 112 illustrated in FIG. 1 and discussed previously.

The exemplary system scenario 200 also may comprise one or more remote memories 230. As mentioned previously, the computing system 210 may comprise local memory 216 in which software, media files, general data, etc. may be stored. Such information may also be stored in one or more remote memories 230. For example, the remote memory 230 may store media files. The remote memory 230 is illustrated as communicatively coupled to the computing system 210 through a communication network 240. A remote memory may also, for example, be communicatively coupled to the computing system 210 via a direct one-to-one link (e.g., a wired link, wireless link, tethered optical link, non-tethered optical link, etc.). A remote memory may generally be considered to reside at a different premises (or a different room) than the computing system 210, where a local memory may generally be considered to reside at the same premises at the computing system (e.g., in the same room or same chassis as the computing system 210). The remote memory 230 may also, for example, be a component of a media file creating and/or presenting device (e.g., a camera, video recorder, audio recorder, picture/video presentation device, audio presentation device, etc.). For example and without limitation, the remote memory 230 may comprise one or more stores of media files, such as the first and/or second memories 111, 112 illustrated in FIG. 1 and discussed previously.

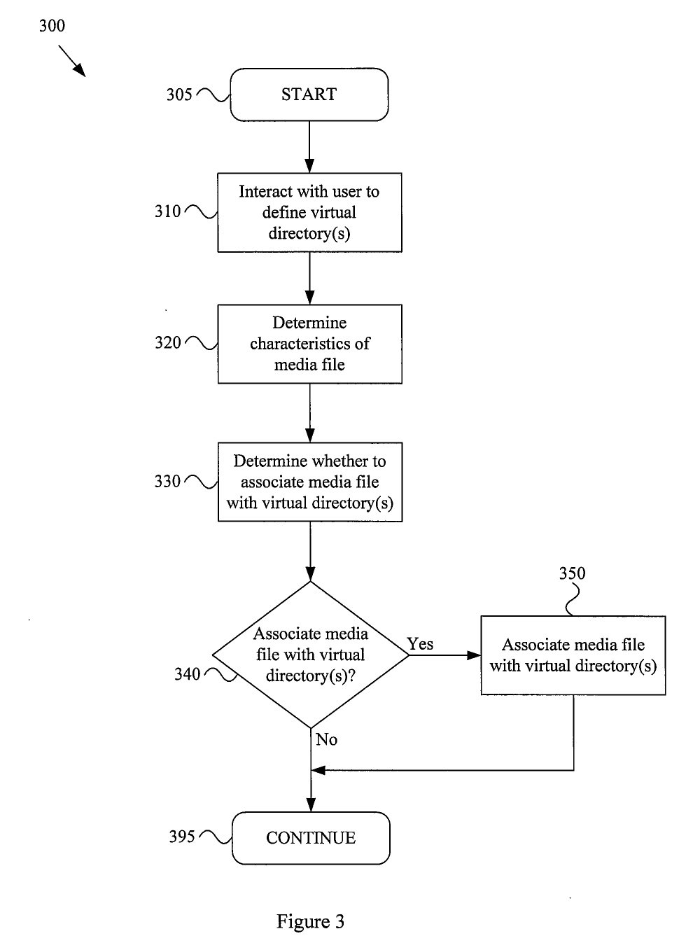

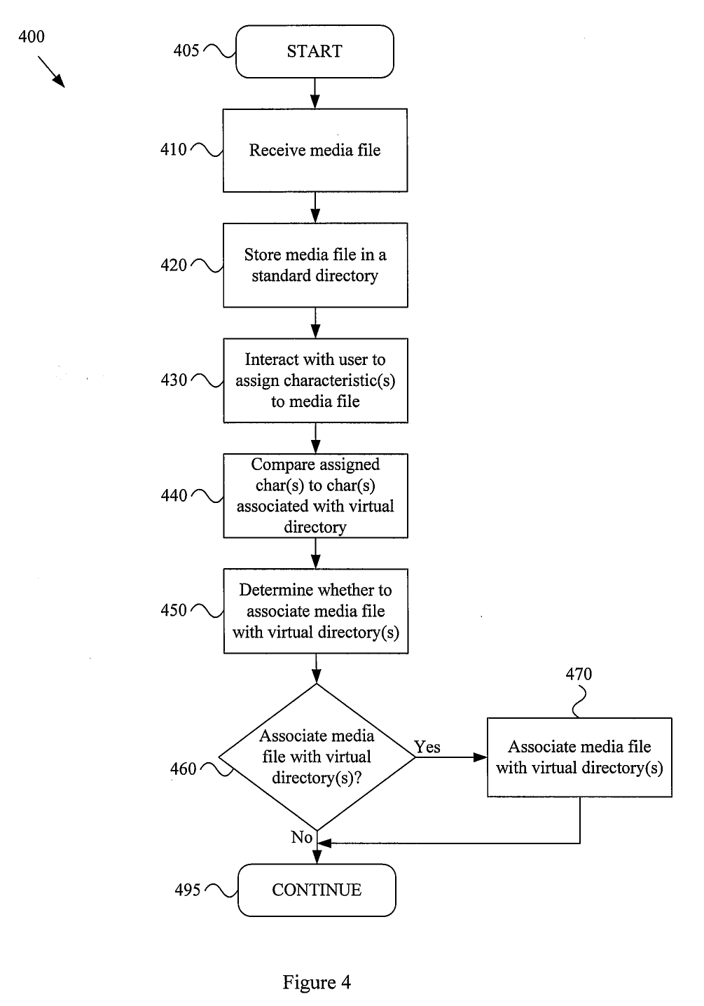

The exemplary computing system 210 may also comprise one or more processors 215. Such processor(s) 215 may comprise characteristics of any of a variety of processing circuits. For example and without limitation, such processor(s) 215 may comprise characteristics of any of a variety of microprocessors, microcontrollers, co-processors, digital signal processors, media processors, user I/O processors, signal processing circuits, application-specific processors, etc. The computing system 210 may, for example, utilize the one or more processors 215 to perform any of a variety of signal processing, operational management, media file management, and/or program execution activities. The processors(s) 215 may also direct the operation of other components of the computing system 210 or of the exemplary system scenario 200. For example and without limitation, the processor(s) 215 may execute software instructions stored in the memory 216 to perform, participate in the performance or, or direct the performance of at least any or all of the functions described later with regard to FIGS. 3-5. In a first particular example, the processor(s) 215 may execute software instructions stored in the memory 216 to perform, participate in the performance of, or direct the performance of at least any or all of the functions described later with regard to FIG. 3. In a second particular example, the processor(s) 215 may execute software instructions stored in the memory 216 to perform, participate in the performance of, or direct the performance of at least any or all of the functions described later with regard to FIG. 4.

The exemplary system scenario 200 may comprise one or more electronic devices (e.g., media devices). Such electronic devices (e.g., consumer electronic devices) may, for example, operate to create media files and communicate such media files to the computing system 210. Media devices may, for example, generally create media files (e.g., cameras, video recorders, scanners, audio recorders, etc.). Such media devices may also, for example, present media to a user (e.g., video players, MP3 players etc.).

The exemplary system scenario 200 comprises a digital camera 221 (e.g., a stand-alone camera, camera on a portable phone or PDA, etc.). A user may, for example, utilize the digital camera 221 to create and/or provide still or moving image files. The digital camera 221 may then communicate with the computing system 210 (shown via a wireless communication link in FIG. 2) to communicate the image files to the computing system 210. The exemplary system scenario 200 also comprises a digital video recorder 222 (e.g., a stand-alone camcorder, camera on a portable phone or PDA, etc.). A user may, for example, utilize the digital video recorder 222 to create and/or provide still or moving image files. The digital video recorder 222 may then communicate with the computing system 210 (shown via a wired communication link in FIG. 2) to communicate the image files to the computing system 210.

The exemplary system scenario 200 further comprises an audio recording and/or presentation device 223 (e.g., digital dicta-phone, MP3 player, etc.). A user may, for example, utilize the audio recording and/or presentation device 223 to create and/or provide audio files. The audio recording and/or presentation device 223 may then communicate with the computing system 210 (shown via a wireless communication link in FIG. 2) to communicate the audio files to the computing system 210. Similarly, though not illustrated, the exemplary system scenario 200 may also comprise an image (still or moving) presentation device that creates and/or provides image files to the computing system 210 over a communication link.

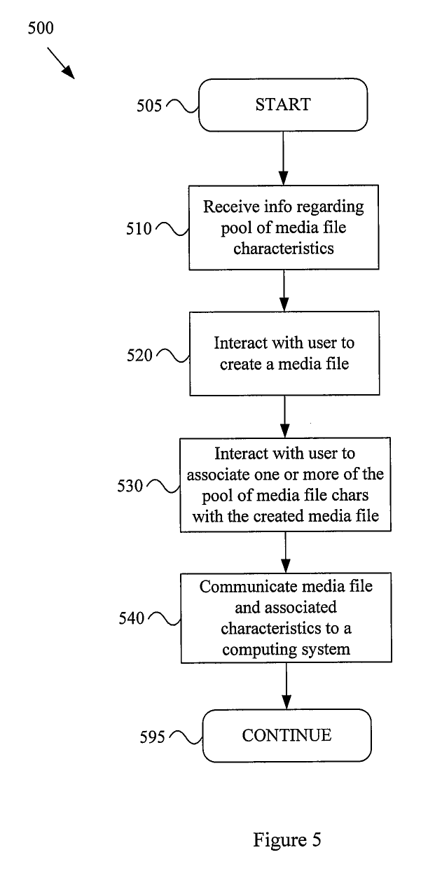

The exemplary electronic devices 221-223 (e.g., media devices) may, for example and without limitation, comprise any or all of the components discussed previously with regard to the computing system 210 (e.g., user interface module(s) 211, communication interface module(s) 218, memory(s) 216 and/or processor(s) 215). For example, an electronic device (e.g., any of the media devices 221-223 illustrated in FIG. 2), or components thereof (e.g., a processor), may operate to perform, participate in the performance, or direct the performance of any or all of the functions presented later with regard to FIGS. 3-5. In a first particular example, an electronic device (e.g., any of the media devices 221-223 illustrated in FIG. 2), or components thereof (e.g., a processor), may perform, participate in the performance of, or direct the performance of any or all of the functions described later with regard to FIG. 5.

The exemplary electronic devices 221-223 (e.g., media devices) are merely illustrative and non-limiting. Accordingly, the scope of various aspects of the present invention should not be limited by characteristics of any particular type of electronic or media device unless explicitly claimed.

In a non-limiting exemplary scenario, a user may utilize any of the electronic devices 221-223 (e.g, media devices) to create or acquire media files, which may then be downloaded to the computing system 210 or to remote memory 230. The computing system 210 may then operate to manage the media files. For example and without limitation, the computing system 210 may operate to interact with a user to define virtual directories and/or media file characteristics. Also for example, the computing system 210 and/or electronic devices 221-223 (e.g., media devices) may operate to interact with a user, or may act independently, to associate media file characteristics with particular media files. Further for example, the computing system 210 may operate (e.g., independent of user interaction) to maintain relationships between media files and virtual directories. Still further for example, the computing system 210 may operate to present such virtual directories to a user in a user-perceivable form.

FIG. 3 is a flow diagram illustrating an exemplary method 300 in a computing system for managing media files, in accordance with various aspects of the present invention. As mentioned previously, any or all of the functional aspects of the exemplary method 300 may be performed by a computing system (e.g., the exemplary computing system 210 illustrated in FIG. 2 and discussed previously). Also for example, any or all of the functional aspects of the exemplary method 300 may be performed by an electronic device (e.g., the exemplary electronic devices 221-223 illustrated in FIG. 2 and discussed previously). Further for example, a first portion of the exemplary method 300 may be performed by a computing system, and a second portion of the exemplary method 300 may be performed by an electronic device (e.g., a media device).

The exemplary method 300 begins executing at step 305. The exemplary method 300 may begin executing in response to any of a variety of causes or conditions. For example and without limitation, the exemplary method 300 may begin executing in response to a user command to begin or in response to an operating profile of a computing system (e.g., of a user electronic device and/or computing system implementing the method 300, portions thereof, or a related method). Also for example, the exemplary method 300 may begin executing in response to receiving a media file. The exemplary method 300 may also, for example, begin executing based on a predetermined schedule of operation. The scope of various aspects of the present invention should not be limited by characteristics associated with any particular initiating cause or condition.

The exemplary method 300 may, for example, at anytime before, during and/or after execution of the exemplary method 300, comprise receiving one or more media files and storing the received media files in memory (e.g., local or remote memory). Various examples of such receiving and/or storing will be presented later in the discussion of FIG. 4.

The exemplary method 300 may, for example at step 310, comprise interacting with a user to define one or more virtual file directories for media files. A virtual media file directory may, for example, be defined, at least in part, by characteristics shared by media files associated with the virtual directory. The media files of the virtual directory may each, for example, comprise a first set of one or more particular characteristics.

Step 310 may, for example, comprise interacting with a user to receive information from the user regarding a media file characteristic or a plurality of media file characteristics to be associated with a virtual directory. Such media file characteristics may, for example be user-defined (i.e., originating from a user), system-defined (e.g., predefined or default media file characteristics) or a combination thereof. A system-defined media file characteristic may, for example, be a predefined general media file characteristic common to a plurality of computing systems.

More discussion regarding the creation, selection and/or assignment of such media file characteristics may, for example, be found later in the discussion of FIG. 4.

A set of media file characteristics with which a virtual directory is associated may be defined as a simple list of one or more media file characteristics, but may also assume more complex forms. For example, such a set of media file characteristics may be defined by the existence and/or non-existence of various media file characteristics. Further for example, such a set of media file characteristics may be defined by logical associations or equations (e.g., utilizing various logical operations such as NOT, OR, AND, NOR, NAND, XOR, etc.). In a simple example, a user may define a virtual directory as a one-to-one relationship between the virtual directory and a particular media file characteristic. In a relatively complex example, a user may define a virtual directory in terms of a logic equation including a plurality of particular media file characteristics and the absence of particular other media file characteristics.

Though the exemplary method 300 will generally discuss a single virtual directory, it should be recognized that the exemplary method 300, or portions thereof, is readily extensible to scenarios involving a plurality of virtual directories. For example, step 310 may comprise interacting with a user to define a second virtual file directory for media files that comprise a second set of one or more particular media file characteristics. In a scenario involving multiple virtual directories, virtual directories may also share one or more associated media file characteristics. For example, in a scenario in which a first virtual file directory is defined for media files that comprise a first set of one or more particular media file characteristics, and a second virtual directory is defined for media files that comprise a second set of one or more particular media file characteristics, the second set and the first set may comprise one or more common members or may be mutually exclusive.

Step 310 may comprise interacting with a user in any of a variety of manners. For example and without limitation, step 310 may comprise receiving an indication from a user that the user desires to create a new virtual directory. Step 310 may then, for example, solicit directory name information from the user and solicit user input regarding the media file characteristics to be associated with the new virtual directory. As a non-limiting example, step 310 may comprise presenting a selectable list (or pool) of media file characteristics to the user. Step 310 may also, for example, present an interface that the user may utilize to form logic equations associated with the media file characteristics. Step 310 may, for example, comprise interacting with the user utilizing a graphical user interface.

Note that step 310 may be performed independent of media file creation. Step 310 may also, for example, comprise interacting with a user to re-define one or more particular virtual directories, which would then be managed by the computing system in accordance with the re-defined characteristics and in accordance with a present collection of media files. In one exemplary scenario, such a modification of a virtual directory may trigger the computing system to re-perform analysis related to determining membership of media files in the re-defined virtual directory.

In general, step 310 may comprise interacting with a user to define a virtual file directory for media files. The previous discussion presented non-limiting examples of such user interaction. The scope of various aspects of the present invention should not be limited by characteristics of the previous examples unless explicitly claimed.

The exemplary method 300 may, at step 320, comprise determining one or more characteristics of a media file. Step 320 may comprise making such determination in any of a variety of manners.

For example and without limitation, step 320 may comprise determining at least one characteristic of the media file that was explicitly assigned to the first media file by a user. As will be discussed in more detail with regard to FIG. 4, a user may assign one or more characteristics to a media file. Information of such characteristics may be assigned to (or associated with) the media file in any of a variety of manners. In such a scenario, step 320 may comprise the computing system analyzing information of such user-assigned characteristics assigned to the media file.

A computing system may assign one or more characteristics to a media file also. For example and without limitation, a computing system (e.g., the computing system implementing the method 300, another computing system, computing device, user electronic device, etc.) may have previously determined particular characteristics of the media file and may have associated information of such determined characteristics with the media file. A computing system may, for example, have performed such analysis independent of user interaction with the computing system. In such a scenario, step 320 may comprise the computing system also analyzing information of such system-defined characteristics assigned to the media file. In such a scenario, a computing system may have assigned one or more characteristics to the media file automatically (e.g., without user initiation or interaction).

In another exemplary scenario, a user may have previously attached a description to the media file (e.g., a textual and/or audio description). In such a scenario, step 320 may comprise the computing system analyzing the attached description to ascertain characteristics of the media file. For example and without limitation, step 320 may comprise analyzing words of a textual description, searching for key words and/or phrases. Such key words and/or phrases may, for example, be associated with particular known media file characteristics.

Step 320 may additionally comprise a computing system automatically specifying characteristics of a media file (e.g., without direct user interaction). For example and without limitation, a computing system may (upon creation of a media file or later) associate information with the media file regarding time, date, location (e.g., GPS coordinates), pointing direction, camera orientation, user identification, media file source, media device setting, etc.

Step 320 may further comprise a computing system analyzing the media contents of the media file to determine particular characteristics of the media file. For example, step 320 may comprise analyzing visual features of an image media file to determine particular characteristics of the image media file. In such a scenario, step 320 may comprise analyzing image characteristics, such as, for example, color, brightness, lighting, etc. Step 320 may also, for example, comprise performing pattern recognition analysis to determine particular characteristics of a media file. In an exemplary scenario where step 320 comprises performing pattern recognition to determine characteristics of a media file, step 320 may comprise performing such analysis utilizing, for example, artificial intelligence analysis, neural networks, etc. In such an exemplary scenario, step 320 may comprise training the pattern recognition over time as the image sample space grows. Similarly, in an audio media file example, step 320 may comprise analyzing audio media information to determine various characteristics thereof (e.g., frequency content, temporal audio density, relative volume, etc.).

In various exemplary scenarios (e.g., in pattern recognition and/or spectral analysis scenarios), step 320 may comprise performing relatively large amounts of processing. Such processing may, for example, run as a background process on a computing system or during periods of low computing system utilization to minimize the impact of such processing on a user of such a computing system. For example and without limitation, any of the processing discussed with regard to steps 320-350 may be performed by background processing. Alternatively, such processing may be performed by one or more other computing systems. Additionally any of steps 320-350 may be initiated and/or performed automatically (e.g., without direct user interaction).

Note that in various scenarios that include a computing system analyzing the media contents of a media file to determine characteristics of the media file, the computing system may assign any of a variety of determined characteristics to the media file. Such determined characteristics may thus be user-defined and/or system-defined.

In general, step 320 may comprise determining one or more characteristics of a media file. As illustrated by numerous examples above, step 320 may comprise making such determination in any of a variety of manners. Accordingly, the scope of various aspects of the present invention should not be limited by characteristics of any of the previous examples unless explicitly claimed.

The exemplary method 300 may, at step 330, comprise determining whether to associate the media file with one or more virtual directories. Step 330 may, for example, base such determination, at least in part, on the media file characteristics determined at step 320. Step 330 may also, for example, base such determination, at least in part, on virtual directory characteristics established at step 310.

In a non-limiting exemplary scenario, a virtual directory may be associated with a first set of media file characteristics, and a media file may be associated with a second set of media file characteristics. Step 330 may comprise analyzing the first and second sets of media file characteristics to determine whether the media file should be associated with the virtual directory.

Step 330 may comprise making such determination in any of a variety of manners. For example and without limitation, in a first exemplary scenario, an exact match between media file characteristics associated with a virtual directory and media file characteristics associated with a media file may result in a determination that the media file should be associated with the virtual directory. Also for example, in a second exemplary scenario, a particular amount of overlap between such respective sets of characteristics may result in a determination that the media file should be associated with the virtual directory. In a third exemplary scenario, any overlap between the media file characteristics associated with a virtual directory and the media file characteristics associated with a media file may result in a determination that the media file should be associated with the virtual directory. In a fourth exemplary scenario involving logical analysis, for a determination to be made that a media file should be associated with a virtual directory, a logical equation utilized to define the virtual directory must be satisfied by the characteristics of the media file.

In general, step 330 may comprise determining whether to associate a media file with a virtual directory in any of variety of manners (e.g., based on media file characteristics). Accordingly, the scope of various aspects of the present invention should not be limited by characteristics of any particular manner unless explicitly claimed.

The exemplary method 300 may, at step 340, comprise controlling execution flow of the exemplary method 300. For example, if it is determined at step 330 to associate a media file with a virtual directory, then step 340 may direct execution flow of the exemplary method 300 to step 350 to perform such association. If, however, it is determined at step 330 to not associate a media file with a virtual directory, then step 340 may direct execution flow of the exemplary method 300 to step 395, skipping the association step 350.

The exemplary method 300 may, at step 350, comprise associating the media file with the virtual file directory. Step 350 may comprise performing such association in any of a variety of manners. For example and without limitation, step 350 may comprise storing a link to the media file in a list of such links associated with the virtual file directory. Such a link may, for example, comprise characteristics of a link to a local file storage system (e.g., a local hard drive of a computing system) or a link to a remote file storage system (e.g., a networked memory device, memory of a communicatively coupled electronic device, etc.). Step 350 may, for example, comprise performing such association by generally designating the association between the media file and the virtual file directory in any of a variety of manners.

The exemplary method 300 may, at step 395, comprise performing continued operation. Step 395 may comprise continuing operation in any of a variety of manners. For example and without limitation, step 395 may comprise returning execution flow of the exemplary method 300 back to any previous step (e.g., any of steps 310-330). Such return of execution flow may, for example, correspond to a particular operating condition and/or event (e.g., a timer related event, a received signal related event, a received media file event, a user command event, etc.).

Also for example, such continued operation may comprise interacting with a user to present information of one or more virtual file directories to the user. For example and without limitation, such continued processing may comprise providing a graphical user interface to a user that shows one or more virtual directories and respective associated media files. The characteristics of such a presentation may vary widely depending on particular circumstances and user I/O resources available. In an exemplary scenario, a user interface may be provided that enables a user to select a media file from a virtual directory for presentation to the user, select all files associated with a virtual directory for presentation to the user, manage file membership in a virtual directory (e.g., deleting, moving, adding media files, etc.), etc.

Such continued processing may, for example, comprise providing a user interface to the user that the user may utilize to manually manage various aspects of the virtual directories. Such a user interface may also, for example, comprise various user interface mechanisms that allow the user to search through virtual directories and/or media files, sort media files stored in virtual directories, change characteristics of virtual directories and/or media file characteristics, etc. Such searching and/or sorting may, for example, comprise searching through characteristics associated with virtual directories and/or media files, descriptions of virtual directories and/or media files, etc.

Turning next to FIG. 4, such figure is a flow diagram illustrating an exemplary method 400 in a computing system for managing media files, in accordance with various aspects of the present invention. The exemplary method 400 may share any or all characteristics with the exemplary method 300 illustrated in FIG. 3 and discussed previously. For example, any of the steps of the exemplary method 300 may be combined with any of the steps of the exemplary method 400.

As mentioned previously, any or all of the functional aspects of the exemplary method 400 may be performed by a computing system (e.g., the exemplary computing system 210 illustrated in FIG. 2 and discussed previously). Also for example, any or all of the functional aspects of the exemplary method 400 may be performed by an electronic device (e.g., the exemplary media devices 221-223 illustrated in FIG. 2 and discussed previously). Further for example, a first portion of the exemplary method 400 may be performed by a computing system, and a second portion of the exemplary method 400 may be performed by an electronic device (e.g., a media device).

The exemplary method 400 begins executing at step 405. The exemplary method 400 may begin executing in response to any of a variety of causes or conditions. For example and without limitation, the exemplary method 400 may begin executing in response to a user command to begin or in response to an operating profile of a computing system (e.g., of a user electronic device and/or computing system implementing the method 400, portions thereof, or a related method). Also for example, the exemplary method 400 may begin executing in response to receiving a signal indicative of the arrival of a media file. The exemplary method 400 may also, for example, begin executing based on a predetermined schedule of operation. The scope of various aspects of the present invention should not be limited by characteristics associated with any particular initiating cause or condition.

The exemplary method 400 may, at step 410, comprise receiving a media file. Step 410 may comprise receiving a media file in any of a variety of manners. For example and without limitation, step 410 may comprise receiving a media file from a user electronic device (e.g., a media device) or another computing system that is communicatively coupled to the computing system implementing the method 400 (e.g., directly or through a communication network). As a first non-limiting example, step 410 may comprise receiving the media file from a digital camera, digital audio recorder and/or media playing device. As a second non-limiting example, step 410 may comprise receiving the media file from a networked database or server.

The exemplary method 400 may, at step 420, comprise storing the received media file and placing it in a standard file directory. Various characteristics of such a standard file directory were discussed previously. For example and without limitation, step 420 may comprising storing the received media file in a local memory of the computing system implementing the method 400 and associating the stored media file with a standard file directory. Also for example, step 420 may comprise storing the received media file in a remote memory that is communicatively coupled to the computing system implementing the method 400, for example through a communication network, and associating the stored media file with a standard file directory.

The exemplary method 400 may, at step 430, comprise interacting with a user to assign a set of one or more particular characteristics to the received media file. As discussed briefly with regard to the method 300 illustrated in FIG. 3, a user (or alternatively a computing system) may assign (or “tag”) one or particular characteristics to a media file. Various non-limiting examples of such media file characteristics were presented previously.

In a non-limiting exemplary scenario, step 430, or a prior step, may comprise interacting with a user to define a pool of media file characteristics (e.g., media file characteristics that are of interest to the user). Such a pool of media file characteristics may, for example, comprise user-defined characteristics and system-defined (or pre-defined) characteristics (e.g., general media file characteristics that may be determined at design time prior to user interaction with the system).

Step 430 may, for example, comprise providing a user interface with which the user may select one or more characteristics from a pool of media characteristics to be associated with the media file. In one non-limiting exemplary scenario, step 430 may comprise presenting the pool of media characteristics to the user in a list form, where each member of the list is associated with a selectable graphical feature with which a user may indicate selection of the member to be associated with the media file.

In an exemplary scenario where step 430 comprises presenting a pool of selectable media file characteristics to a user, step 430 may also comprise determining a particular manner (e.g., a particular order) in which to present the pool to the user. As a non-limiting example, step 430 may comprise determining one or more most likely media file characteristics to be selected by the user and present such most likely selected characteristics of the pool to the user for relatively convenient selection. For example, step 430 may comprise presenting such most likely selected characteristics near the top of a list of a pool of selectable media file characteristics. Step 430 may base such a prioritization on a variety of factors, for example, most popular selections, most likely selections based on other characteristics of the media file (e.g., location, time, date, etc.), most recent selections, etc.

Step 430 may comprise assigning characteristics (e.g., as indicated or selected by the user) to the media file in any of a variety of manners. For example and without limitation, step 430 may comprise attaching data indicative of the assigned first set to the first media file. Such data may, for example, be attached as a related (or linked) file or data structure or may be included as data internal to the media file (e.g., as metadata). Various aspects may, for example, comprise attaching information of such characteristics (e.g., user-defined and/or user-specified characteristics) to a media file as an extension to an existing media file standard.

Though the exemplary method 400 illustrates the assignment of characteristics to the media file immediately after receipt and storage of the media file by the computing system, the assignment of characteristics to the media file may occur at any of a variety of times. For example, the assignment of characteristics to the media file may occur when the media file is originally created (e.g., at a camera or audio recording device) or obtained (e.g., transferred from another computing system, database, server, etc.). Also for example, the assignment of characteristics may occur long after a media file is received and/or stored. Thus, the scope of various aspects of the present invention should not be limited by the relative positioning of step 430 in the exemplary method 400 unless explicitly claimed.

Also, though the exemplary step 430 comprises interacting with a user to assign a set of one or more particular characteristics to the received media file, step 430 may alternatively (or in addition to) comprise automatically (e.g., by the computing system without direct interaction with the user) assigning one or more particular characteristics to the received media file. The automatic assignment of various characteristics to a media file by a computing system (e.g., stemming from analysis of the media file by the computing system) was generally discussed previously in the discussion of FIG. 3.

Step 430 may generally comprise interacting with a user to assign one or more characteristics to the media file. Though various examples were presented previously, the scope of various aspects of the present invention should not be limited by characteristics of such examples unless explicitly claimed.

The exemplary method 400 may, at step 440, comprise comparing the set of one or more particular characteristics assigned to the received media file with the set of one or more particular characteristics associated with a virtual directory. The exemplary method 400 may, at step 450, comprise determining, based at least on the comparison of step 440, whether to associate the media file with the virtual directory. Steps 440 and 450 may, for example, share any or all characteristics with step 330 of the exemplary method 300 illustrated in FIG. 3 and discussed previously.

Steps 440 and 450 may, for example, comprise performing such comparison and making such determination in any of a variety of manners. For example and without limitation, in a first exemplary scenario, an exact match between media file characteristics associated with a virtual directory and media file characteristics associated with a media file may result in a determination that the media file should be associated with the virtual directory. Also for example, in a second exemplary scenario, a particular amount of overlap between such respective sets of characteristics may result in a determination that the media file should be associated with the virtual directory (e.g., a one-member overlap, two-member overlap, n-member overlap, etc.). In a third exemplary scenario, any overlap between the media file characteristics associated with a virtual directory and the media file characteristics associated with a media file may result in a determination that the media file should be associated with the virtual directory. In a fourth exemplary scenario involving logical analysis, for a determination to be made that a media file should be associated with a virtual directory, a logical equation utilized to define the virtual directory must be satisfied by the characteristics of the media file.

The exemplary method 400 may, at step 460, comprise controlling execution flow of the exemplary method 400. For example, if it is determined at step 450 to associate a media file with a virtual directory, then step 460 may direct execution flow of the exemplary method 400 to step 470 to perform such association. If, however, it is determined at step 450 to not associate a media file with a virtual directory, then step 460 may direct execution flow of the exemplary method 400 to step 495, skipping the association step 470.

The exemplary method 400 may, at step 470, comprise associating the media file with the virtual file directory. Step 470 may comprise performing such association in any of a variety of manners. For example and without limitation, step 470 may comprise storing a link to the media file in a list of such links associated with the virtual file directory. Such a link may, for example, comprise characteristics of a link to a local file storage system (e.g., a local hard drive of a computing system) or a link to a remote file storage system (e.g., a networked memory device, communicatively coupled electronic device, etc.). Step 470 may, for example, comprise performing such association by generally designating the association between the media file and the virtual media file directory in any of a variety of manners.

The exemplary method 400 may, at step 495, comprise performing continued operation. Step 495 may comprise continuing operation in any of a variety of manners. For example and without limitation, step 495 may comprise returning execution flow of the exemplary method 400 back to any previous step (e.g., any of steps 410-450). Such return of execution flow may, for example, correspond to a particular operating condition and/or event (e.g., a timer related event, a received signal related event, a received media file event, a user command event, etc.).

Also for example, such continued operation may comprise interacting with a user to present information of one or more virtual file directories to the user. For example and without limitation, such continued processing may comprise providing a graphical user interface to a user that shows one or more virtual directories and respective associated media files. The characteristics of such a presentation may vary widely depending on particular circumstances and user I/O resources available. In an exemplary scenario, a user interface may be provided that enables a user to select a media file from a virtual directory for presentation to the user, select all files associated with a virtual directory for presentation to the user, manage file membership in a virtual directory (e.g., deleting, moving, adding media files, etc.).

For example and without limitation, any of the processing discussed with regard to steps 410-420 and 440-470 may be performed by background processing. Also, such processing may be performed by one or more other computing systems. Additionally any of steps 410-420 and 440-470 may be initiated and/or performed automatically (e.g., without direct user interaction).

FIG. 5 is a flow diagram illustrating an exemplary method 500 in an electronic device for managing media files, in accordance with various aspects of the present invention. The exemplary method 500 may share any or all characteristics with the exemplary methods 300, 400 illustrated in FIGS. 3-4 and discussed previously. For example, any of the steps of such exemplary methods 300, 400 may be combined with any of the steps of the exemplary method 500 shown in FIG. 5.

As mentioned previously, any or all of the functional aspects of the exemplary method 500 may be performed by a computing system (e.g., the exemplary computing system 210 illustrated in FIG. 2 and discussed previously). Also for example, any or all of the functional aspects of the exemplary method 500 may be performed by an electronic device (e.g., the exemplary media devices 221-223 illustrated in FIG. 2 and discussed previously). Further for example, a first portion of the exemplary method 500 may be performed by a computing system, and a second portion of the exemplary method 500 may be performed by an electronic device. Thus, though the following discussion will generally be from the perspective of an electronic device (e.g., a media device), the scope of various aspects of the present invention should not be limited by characteristics of any particular electronic device (e.g., a media device) or system that may implement the exemplary method 500 or a portion thereof.

The exemplary method 500 begins executing at step 505. The exemplary method 500 may begin executing in response to any of a variety of causes or conditions. For example and without limitation, the exemplary method 500 may begin executing in response to a user command to begin (e.g., a user command entered at an electronic device and/or computing system interacting with an electronic device). Also for example, the exemplary method 500 may begin executing in response to an operating profile of an electronic device or computing system (e.g., of an electronic device and/or computing system implementing the method 500, portions thereof, or a related method). Additionally for example, the exemplary method 500 may begin executing in response to receiving a signal indicative of the creation and/or arrival of a media file. The exemplary method 500 may also, for example, begin executing based on a predetermined schedule of operation. The scope of various aspects of the present invention should not be limited by characteristics associated with any particular initiating cause or condition.

The exemplary method 500 may, at step 510, comprise receiving information of a pool of media file characteristics. Various examples of such media file characteristics were presented previously. For example and without limitation, the pool of media file characteristics may be user-defined and/or system-defined. For example and without limitation, a pool of media file characteristics may have been created by interacting with a user.

In a non-limiting exemplary scenario, a user (e.g., of an electronic device and/or a computing system) might have created and/or organized virtual media file directories. In such a scenario, the pool of media file characteristics may, for example, include media file characteristics that are associated with membership of media files in various virtual directories.

Step 510 may comprise receiving the pool of media file characteristics in any of a variety of manners. For example and without limitation, step 510 may comprise receiving information of the pool of media file characteristics directly from a user through a user interface. Step 510 may also, for example, comprise receiving information of the pool of media file characteristics from a computing system different from the electronic device (e.g., media device) executing the exemplary method 500. In a non-limiting exemplary scenario, step 510 may comprise receiving information describing the pool of media file characteristics from a computing system that is implementing various aspects of the exemplary methods 300, 400 illustrated in FIGS. 3-4 and discussed previously. In such a scenario, step 510 may comprise establishing a communication link between the electronic device implementing the exemplary method 500 and the computing system and receiving information of the pool of media file characteristics over the communication link.

The exemplary method 500 may, at step 520, comprise interacting with a user of the electronic device (e.g., a media device) to create a media file. For example and without limitation, step 520 may comprise interacting with a user of a camera, audio recording device, video camera, scanner, etc. to create a media file original to the user (e.g., a picture file, audio file, video file, etc.). In another non-limiting exemplary scenario, step 520 may comprise interacting with a user of an electronic device (e.g., a media device) to acquire a copy of a media file from a source of media files (e.g., via a direct communication link or over a communication network).

The exemplary method 500 may, at step 530, comprise interacting with a user of the electronic device to associate one or more of the pool of media file characteristics (e.g., as received at step 510) with the media file (e.g., as created or received at step 520). Various non-limiting examples of such interaction were discussed previously with regard to step 430 of the exemplary method 400 illustrated in FIG. 4 and discussed previously. Step 530 may, for example and without limitation, comprise implementing any portion of such previous examples in an electronic device (e.g., a media device). Step 530 may, for example, comprise interacting with a user utilizing the particular user interface features of the electronic device (e.g., media device) implementing step 530.

Step 530 may, for example, after receiving input from a user about particular media file characteristics to be associated with a media file, attach information (or data) about the particular media file characteristics to the media file. As discussed previously, such information may, for example, be inserted in a file related to the media file (e.g., linked to the media file in some manner) or may be inserted in the media file (e.g., as metadata). Such attachment of information may generally depend on the nature of the particular media file.

The exemplary method 500 may, at step 540, comprise communicating the media file (e.g., as created at step 520), along with information of associated media file characteristics (e.g., as associated at step 530) to a computing system. Such communication may occur in any of a variety of manners (e.g., via direct wired or wireless link or via any of a large variety of types of communication networks).

For example and without limitation, step 540 may comprise communicatively coupling to a computing system external to the electronic device (e.g., the media device). Step 540 may then, for example, comprise communicating the created media file and information of the associated media file characteristic(s) to the computing system over the communicative coupling.

Step 540 may, for example, comprise communicating a plurality of media files and associated media file characteristics to the computing system. For example, the previous discussion generally referred to one media file for illustrative clarity. It should be recognized that various steps prior to step 540 may be repeated a plurality of times prior to the communication of media file information and/or information of associated media file characteristics to the computing system. For example, steps 520 and/or 530 may be repeated numerous times prior to the execution of step 540.

In a non-limiting exemplary scenario, a user of a digital camera may utilize the camera to create an image file. The digital camera, having previously obtained information regarding a pool of media file characteristics that may be associated with the image file, may present information of the pool of media file characteristics to the user. The user may then, for example, select particular media file characteristics from the pool of media file characteristics to attach to the media file. Subsequently, the media file and information of the associated characteristics (which may be separate from or part of the media file) may be transferred from the digital camera to a computing system. Such a computing system may then, for example, operate to manage the downloaded media file (e.g., in accordance with any or all of the functionality discussed previously with regard to the exemplary methods 300, 400 of FIGS. 3-4).

The exemplary method 500 may, at step 595, comprise performing continued operation. Step 595 may comprise continuing operation in any of a variety of manners. For example and without limitation, step 595 may comprise returning execution flow of the exemplary method 500 back to any previous step (e.g., any of steps 510-530). Such return of execution flow may, for example, correspond to a particular operating condition and/or event (e.g., a timer related event, a received signal related event, a received media file event, a user command event, etc.).

Various exemplary structural and/or functional aspects of the present invention were illustrated in FIGS. 1-5 and discussed previously. Various aspects of the present invention may be implemented in any of a variety of manners. For example and without limitation, any or all functional aspects of the present invention may be implemented by hardware, software and/or a combination thereof. For example, the various functional blocks illustrated in FIGS. 3-5 may be implemented by hardware and/or software, non-limiting examples of which were presented at FIG. 2. As a non-limiting example, various blocks may also be implemented in one or more processors and/or integrated circuits.

Additionally, various aspects of the present invention were illustrated and discussed modularly. It should be recognized that various module boundaries were established and presented for illustrative clarity. For example, various modules may share various hardware and/or software components. Also for example, various modules may be implemented separately (e.g., in respective integrated circuits or a combined integrated circuit).

In summary, various aspects of the present invention provide a system and method for managing media utilizing virtual directories.

While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. In a computing system, a method for managing media files, the method comprising:
interacting with a user to define a first virtual file directory for media files that each comprise a first set of one or more particular characteristics, the media files associated with one or more standard file directories different from the virtual file directory;
determining one or more characteristics of a first media file;
determining, based at least in part on the determined characteristic(s) of the first media file, whether the first media file comprises the first set of one or more particular characteristics;
if it is determined that the first media file comprises the first set of one or more particular characteristics, then associating the first media file with the first virtual file directory; and
presenting the first virtual file directory to a user.

2. The method of claim 1, wherein interacting with a user to define a first virtual file directory comprises interacting with the user to receive information of a plurality of media file characteristics to associate with the first virtual file directory.

3. The method of claim 1, further comprising interacting with a user to define a second virtual file directory for media files that each comprise a second set of one more particular characteristics, the second set comprising at least one member of the first set.

4. The method of claim 1, wherein at least one of the first set of one or more characteristics is a custom characteristic defined by the user.

5. The method of claim 1, wherein at least one of the first set of one or more characteristics is a predefined general characteristic common to a plurality of computing systems.

6. The method of claim 1, wherein the first set of one or more particular characteristics is, at least in part, defined by the absence of one or more particular characteristics.

7. The method of claim 1, wherein the first set of one or more particular characteristics is, at least in part, defined by a user-specified logic equation.

8. The method of claim 1, wherein determining one or more characteristics of a first media file comprises determining at least one characteristic of the first media file that was explicitly assigned to the first media file by a user.

9. The method of claim 1, wherein determining one or more characteristics of a first media file comprises determining at least one characteristic of the first media file that was assigned automatically, without user interaction, to the first media file.

10. The method of claim 1, wherein determining one or more characteristics of a first media file comprises determining at least one characteristic of the first media file by analyzing a description of the first media file.

11. The method of claim 1, wherein the first media file is a picture file.

12. The method of claim 1, wherein the first media file is an audio file.

13. The method of claim 1, further comprising receiving the first media file and storing the first media file in memory of the computing system.

14. The method of claim 1, further comprising receiving the first media file from a digital camera and storing the first media file in memory of the computing system.

15. The method of claim 1, wherein at least the step of associating is performed independent of a real-time user request triggering performance of such step.

16. The method of claim 1, wherein associating the first media file with the first virtual file directory comprises adding a designation of the first media file to a list of media files associated with the first virtual file directory.

17. In a computing system, a method for managing media files, the method comprising:
receiving a first media file;
interacting with a user to assign a first set of one or more particular characteristics to the received first media file;
comparing the first set of one or more particular characteristics assigned to the received first media file with a second set of one or more particular characteristics associated with a first virtual directory, the first virtual directory different from a standard directory with which the first media file is associated;
determining, based at least in part on the comparison, whether to associate the received first media file with the first virtual directory;
if it is determined to associate the received first media file with the first virtual directory, then associating the received first media file with the first virtual directory; and
presenting the first virtual directory to a user.

18. The method of claim 17, further comprising storing the received first media file in memory of the computing system and associating the received first media file with a standard file directory of the computing system.

19. The method of claim 17, wherein receiving the first media file comprises receiving the first media file from a digital camera.

20. The method of claim 17, further comprising interacting with a user to define a pool of media file characteristics.

21. The method of claim 20, wherein interacting with a user to assign a first set of one or more particular characteristics to the received first media file comprises providing a user interface with which the user may select one or more characteristics from the pool of media file characteristics.

22. The method of claim 20, wherein the pool of media file characteristics comprises system-defined characteristics and pre-defined characteristics that are not defined by the user.

23. The method of claim 17, wherein interacting with a user to assign a first set of one or more particular characteristics to the received first media file comprises presenting a pool of media file characteristics to the user from which characteristics may be selected.

24. The method of claim 23, wherein presenting a pool of media file characteristics to the user comprises presenting the pool of media file characteristics in a manner that is adaptable based, at least in part, on previous characteristic selections.

25. The method of claim 17, further comprising attaching data indicative of the assigned first set to the first media file.

26. The method of claim 25, wherein attaching data indicative of the assigned first set to the first media file comprises including the data as metadata of the first media file.

27. The method of claim 17, wherein determining, based at least in part on the comparison, whether to associate the received first media file with the first virtual directory comprises determining whether each member of the second set of characteristics is a member of the first set of characteristics.

28. The method of claim 17, wherein determining, based at least in part on the comparison, whether to associate the received first media file with the first virtual directory comprises determining whether at least one member of the second set of characteristics is a member of the first set of characteristics.

29. The method of claim 17, wherein the comparing and determining steps are performed independent of a real-time user request triggering the performance of such steps.

30. The method of claim 17, wherein the comparing and determining steps are performed as a background process executing on the computing system.

31. In an electronic device, a method for managing media files, the method comprising:
receiving information of a pool of media file characteristics, at least one of the pool of media file characteristics being user-defined;
interacting with a user of the electronic device to create a media file; and
interacting with a user of the electronic device to associate one or more of the pool of media file characteristics with the created media file.

32. The method of claim 31, further comprising:
communicatively coupling to a computing system external to the electronic device; and
communicating the created media file and information of the associated media file characteristic(s) to the computing system.

33. The method of claim 31, wherein interacting with a user of the electronic device to associate one or more of the pool of media file characteristics with the created media file comprises inserting information of the associated media file characteristics in the media file.

34. The method of claim 31, wherein the electronic device comprises a digital camera.

35. The method of claim 31, wherein the electronic device comprises a digital audio recorder.

36. In a computing system that operates to manage media files, electrical circuitry comprising:
at least one processor that operates to, at least:
cause the computing system to interact with a user to define a first virtual file directory for media files that each comprise a first set of one or more particular characteristics, the media files associated with one or more standard file directories different from the virtual file directory;
determine one or more characteristics of a first media file;
determine, based at least in part on the determined characteristic(s) of the first media file, whether the first media file comprises the first set of one or more particular characteristics;
if it is determined that the first media file comprises the first set of one or more particular characteristics, then associate the first media file with the first virtual file directory; and
cause the computing system to present the first virtual file directory to a user.

37. In a computing system that operates to manage media files, electrical circuitry comprising:
a least one processor that operates to, at least:
cause the computing system to receive a first media file;
cause the computing system to interact with a user to assign a first set of one or more particular characteristics to the received first media file;
compare the first set of one or more particular characteristics assigned to the received first media file with a second set of one or more particular characteristics associated with a first virtual directory, the first virtual directory different from a standard directory with which the first media file is associated;
determine, based at least in part on the comparison, whether to associate the received first media file with the first virtual directory;
if it is determined to associate the received first media file with the first virtual directory, then associate the received first media file with the first virtual directory; and
cause the computing system to present the first virtual directory to a user.

38. In an electronic device that operates to manage media files, electrical circuitry comprising:
a least one processor that operates to, at least:
receive information of a pool of media file characteristics, at least one of the pool of media file characteristics being user-defined;
interact with a user of the electronic device to create a media file; and
interact with a user of the electronic device to associate one or more of the pool of media file characteristics with the created media file.
